(19) United States
(12) Patent Application Publication
(10) Pub. No.: US 2017/0235356 A1
(43) Pub. Date: Aug. 17, 2017

(54) ELECTRONIC DEVICE AND METHOD OF REDUCING POWER THEREOF

(71) Applicant: ELECTRONICS AND TELECOMMUNICATIONS RESEARCH INSTITUTE, Daejeon (KR)

(72) Inventor: Jin Ho ON, Sejong-si (KR)

(21) Appl. No.: 15/183,949

(22) Filed: Jun. 16, 2016

(30) Foreign Application Priority Data
Feb. 12, 2016 (KR) 10-2016-0016216

(51) Int. Cl. G06F 1/32

(52) U.S. Cl. CPC G06F 1/3206; G06F 1/3253; G06F 1/3262; G06F 1/3296

(57) ABSTRACT

An electronic device includes a system bus, a hardware including a plurality of physical devices connected to the system bus, and a power controller connected to the system bus to collect through the system bus state information about each of the plurality of physical devices, select a specific category corresponding to the collected state information by using a previously constructed decision-making tree model, and control an operation of each of the plurality of physical devices according to a power reduction policy mapped to the selected specific category.

### CROSS-REFERENCE TO RELATED APPLICATIONS

This application claims priority under 35 U.S.C. §119 to Korean Patent Application No. 10-2016-0016216, filed on Feb. 12, 2016, the disclosure of which is incorporated herein by reference in its entirety.

### BACKGROUND OF THE INVENTION

1. Field of the Invention

The present invention relates to an electronic device, and more particularly, to an electronic device which operates at low power.

2. Description of Related Art

Computer systems are managed in a complicated form by an operating system (OS) or an integrated management system. In such a management environment, state information about the computer systems is very important information for efficiently operating the computer systems. Here, the state information about the computer systems may include, for example, a total central processing unit (CPU) load factor or a load factor for each core, a memory utilization rate, an input/output (I/O) utilization rate, a network utilization rate, used power, cycles per instruction, etc.

Most of management systems determine state information about a computer system, based on the above-listed values and controls the computer system according to the determined state information. However, such a management method does not perform management according to a detailed reference based on a situation, and for this reason, it is unable to perform control optimized for each situation.

### SUMMARY

Accordingly, the present invention provides an electronic device and a method of reducing power thereof, which classify state information about a system into various categories by using a decision-making tree based on a user policy, and perform control based on the user policy mapped to a category corresponding to a current state of the system.

In one general aspect, an electronic device includes: a system bus; a hardware including a plurality of physical devices connected to the system bus; and a power controller connected to the system bus to collect through the system bus state information about each of the plurality of physical devices, select a specific category corresponding to the collected state information by using a previously constructed decision-making tree model, and control an operation of each of the plurality of physical devices according to a power reduction policy mapped to the selected specific category.

In another general aspect, a method of reducing power of an electronic device, including a plurality of physical devices connected to a system bus, includes: collecting through the system bus state information about each of the plurality of physical devices; selecting a specific category corresponding to the collected state information by using a previously constructed decision-making tree model; and controlling operations of the plurality of physical devices according to a power reduction policy mapped to the selected specific category.

Other features and aspects will be apparent from the following detailed description, the drawings, and the claims.

### BRIEF DESCRIPTION OF THE DRAWINGS

FIG. 1 is a diagram illustrating a system configuration of an electronic device according to an embodiment of the present invention.

FIG. 2 is a block diagram illustrating an internal configuration of a power controller illustrated in FIG. 1.

FIG. 3 is a block diagram illustrating an internal configuration of a decision-making tree model generator illustrated in FIG. 2.

FIG. 4 is a diagram illustrating an example of a decision-making tree generated by the decision-making tree model generator illustrated in FIG. 3.

FIG. 5 is a flowchart illustrating a process of a power reduction method in an electronic device according to an embodiment of the present invention.

FIG. 6 is a flowchart illustrating a detailed process of a decision-making tree model illustrated in FIG. 5.

### DETAILED DESCRIPTION OF EMBODIMENTS

Hereinafter, example embodiments of the present invention will be described in detail with reference to the accompanying drawings. Embodiments of the present invention are provided so that this disclosure will be thorough and complete, and will fully convey the concept of the present invention to one of ordinary skill in the art. Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In various embodiments of the disclosure, the meaning of ‘comprise’, ‘include’, or ‘have’ specifies a property, a region, a fixed number, a step, a process, an element and/or a component but does not exclude other properties, regions, fixed numbers, steps, processes, elements and/or components.

As used herein, the term “or” includes any and all combinations of one or more of the associated listed items. For example, “A or B” may include A, include B, or include A and B.

It will be understood that, although the terms first, second, etc. used herein may qualify various elements according to various embodiments, these elements should not be limited by these terms. For example, the terms do not limit the order and/or importance of corresponding elements. These terms are only used to distinguish one element from another. For example, a first user equipment and a second user equipment are user equipment and denote different user equipment. For example, a first element may be referred to as a second element without departing from the spirit and scope of the present invention, and similarly, the second element may also be referred to as the first element.

In the case in which a component is referred to as being “connected” or “accessed” to other component, it should be understood that not only the component is directly connected or accessed to the other component, but also there may exist another component between the components. Meanwhile, in the case in which a component is referred to as being “directly connected” or “directly accessed” to other component, it should be understood that there is no component therebetween.

In the following description, the technical terms are used only for explain a specific embodiment while not limiting the present invention. The terms of a singular form may include plural forms unless referred to the contrary.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

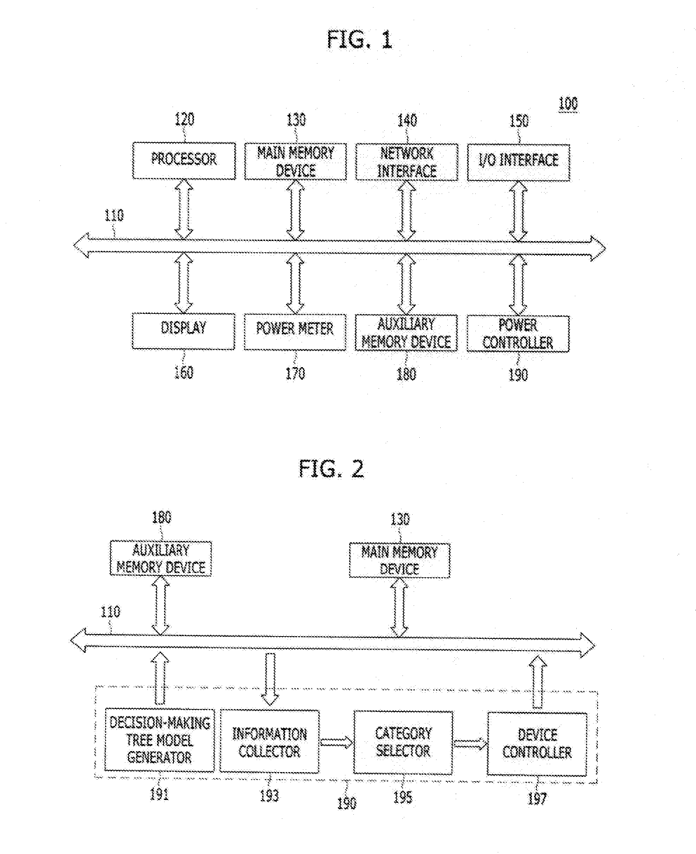

FIG. 1 is a diagram illustrating a system configuration of an electronic device 100 according to an embodiment of the present invention.

Referring to FIG. 1, the electronic device 100 according to an embodiment of the present invention may be a device including a communication function. For example, the electronic device 100 may be a smartphone, a tablet personal computer (PC), a mobile phone, a video phone, an e-book reader, a desktop PC, a laptop PC, a netbook PC, a personal digital assistant (PDA), a portable multimedia player (PMP), an MP3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

In detail, the electronic device 100 may include a system bus 110, hardware including a plurality of physical devices 120, 130, 140, 150, 160, 170, 180 and 190, and a power controller 190. Here, the plurality of physical devices 120, 130, 140, 150, 160, 170, 180 and 190 may include a processor 120, a main memory device 130, a network interface 140, an input/output (I/O) interface 150, a display 160, a power meter 170, an auxiliary memory device 180, and a power controller 190.

The system bus 110 may connect the physical devices 120, 130, 140, 150, 160, 170, 180 and 190 so as to perform communication.

The processor 120 may be connected to the system bus 110. The processor 120 may receive an instruction from the other physical devices 130, 140, 150, 160, 170, 180 and 190 through the system bus 110, decode the received instruction, and perform a data processing operation and a graphic processing operation according to the decoded instruction. Here, the processor 120 may include a graphic processing unit (GPU) and a central processing unit (CPU) including a plurality of cores.

The main memory device 130 may be a device which is connected to the system bus 110 and stores a program, which is being executed by at least one of the processor 120 and the other physical devices 140, 150, 160, 170, 180 and 190, and an instruction or data necessary for the execution. The main memory device 130 may be, for example, a random access memory (RAM) or a read-only memory (ROM).

The main memory device 130 may store, for example, programming modules such as a kernel, middleware, an application programming interface (API), an application, and/or the like. Here, the API may be an interface for the application controlling a function supplied from the kernel or the middleware, and for example, may include at least one interface or function (for example, an instruction) for at least one of file control, window control, image processing, letter control, etc.

The network interface 140 may be connected to the system bus 110 and may perform a series of communication processing operations for transmitting information, received from each of the devices through the system bus 110, to an external network. The network interface 140 may be configured to support at least one communication scheme of wireless fidelity (WiFi), WiFi direct, Bluetooth (BT), near field communication (NFC), global positioning system (GPS), the third generation (3G), long term evolution (LTE), long term evolution-advanced (LTE-A), code division multiple access (CDMA), wideband code division multiple access (WCDMA), universal mobile telecommunications system (UMTS), WiBro, GSM, etc.

The I/O interface 150 may be connected to the system bus 110 and may transmit an instruction or data, input from a user through an I/O device including at least one of a sensor, a keyboard, a touch screen, etc., to the physical devices 120, 130, 140, 160, 170, 180 and 190 through the system bus 110.

The display 160 may be connected to the system bus 110 and may visually provide various pieces of information, which includes an operation result obtained through processing by at least one of the physical devices 120, 130, 140, 150, 170, 180 and 190, such as multimedia data or text data, to the user.

The power meter 170 may be connected to the system bus 110 and may measure the amount of power used (the amount of power consumed) by each of the physical devices 120, 130, 140, 150, 160, 180 and 190. The power meter 170 may include an internal power meter and an external power meter. When the devices 110 to 190 are mounted on one main board (not shown), the internal power meter may be a meter mounted on the main board, and the external power meter may be a meter installed outside the electronic device 100. In the present embodiment, the power meter 170 may be described as an internal power meter.

The auxiliary memory device 180 may be a device that permanently stores a program executed by at least one of the physical devices 120, 130, 140, 150, 160, 170, and 190, a software module, and data necessary for the execution, and for example, may be a hard disk.

The power controller 190 may be connected to the system bus 110. The power controller 190 may collect through the system bus 110 state information about each of the physical devices 120, 130, 140, 150, 160, 170 and 180, select a specific category corresponding to the collected state information by using a previously constructed decision-making tree model, and control an operation of each of the physical devices 120, 130, 140, 150, 160, 170 and 180 according to a power reduction policy mapped to the selected specific category.

The state information may include a state value obtained by digitizing a state of each of the physical devices 120 to 180. The state value may include, for example, a processor utilization rate (a load factor), a memory utilization rate, a network bandwidth utilization rate, an I/O utilization rate, cycles per instruction (CPI), used power, scheduler latency, and/or the like. Here, the processor utilization rate may include a CPU utilization rate and a GPU utilization rate. The CPI denotes cycles used per one instruction when the CPU and/or the GPU execute(s) a program.

The power controller 190 may previously construct (or generate) the decision-making tree model. The decision-making tree model may be stored in the auxiliary memory device 180. The decision-making tree model stored in the auxiliary memory device 180 may be moved to the main memory device 130 when the power controller 190 operates (executes), and may be executed by the main memory device 130.

In FIG. 1, the power controller 190 is illustrated as a hardware module, but is not limited thereto. In other embodiments, the power controller 190 may be implemented as a software module. When the power controller 190 is implemented as the software module, the power controller 190 may be executed in a kernel that connects an operating system (OS) to the physical devices 120 to 180.

FIG. 2 is a block diagram illustrating an internal configuration of the power controller 190 illustrated in FIG. 1.

Referring to FIG. 2, the power controller 190 may include a decision-making tree model generator 191, an information collector 193, a category selector 195, and a device controller 197, for controlling operations of the physical devices 120 to 180 according to a power reduction policy of a user.

The decision-making tree model generator 191 may learn state information about each of the physical devices 120 to 180 to generate a decision-making tree model based on modeling of an optimal power reduction policy.

In detail, the decision-making tree model generator 191 may classify a plurality of power reduction policies, set by the user, into a plurality of categories and may construct a tree structure by using the classified categories to generate the decision-making tree model.

The generated decision-making tree model may be stored in the auxiliary memory device 180. In operating (executing) the power controller 190, the decision-making tree model may be moved to and stored in the main memory device 130 and may be executed in the main memory device 130.

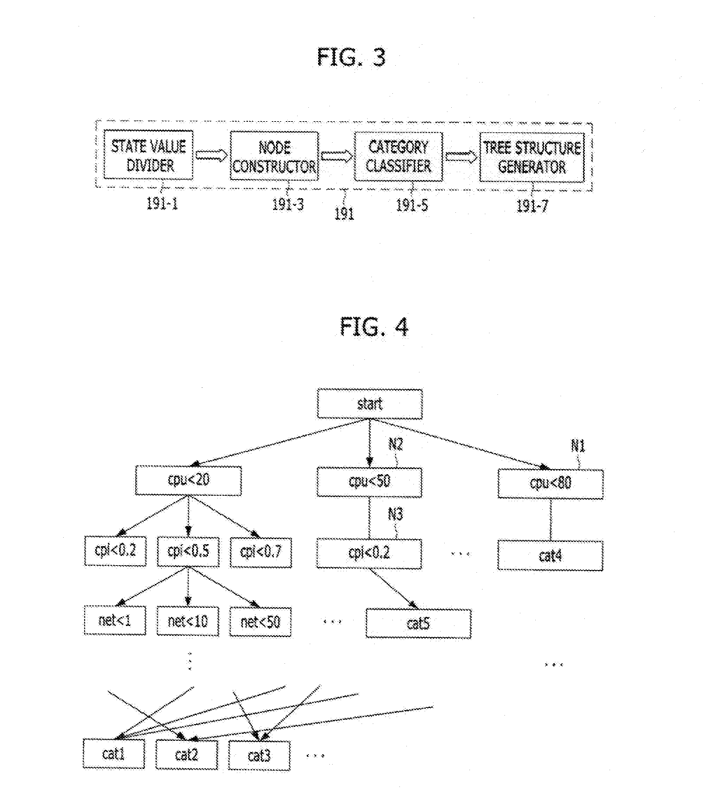

An operation of generating the decision-making tree model will be described with reference to FIG. 3.

The information collector 193 may periodically collect the state information about each of the physical devices 120 to 180.

Each of the physical devices 120 to 180 may transmit the state information thereof to the information collector 193 through the system bus 110 according to a request of information collector 193.

On the other hand, even when there is no request of the information collector 193, each of the physical devices 120 to 180 may transmit the state information thereof to the information collector 193 through the system bus 110 at certain time intervals.

The information collector 193 may collect only state information about devices selected by the user.

The information collector 193 may collect the state information by a sliding window unit.

The information collector 193 may accumulate state values, obtained by digitizing states of the devices, by the number of sliding windows provided for each of the devices and may transfer an average value of the accumulated state values to the category selector 195.

The category selector 195 may select a specific category, corresponding to state information (or the average value) collected by the information collector 193, from among the plurality of categories classified based on the decision-making tree model executed by the main memory device 130.

The device controller 197 may generate an operation instruction for controlling operations of the devices, based on a power reduction policy mapped to the specific category selected by the category selector 195 and may transmit the generated operation instruction to the devices through the system bus 110.

Corresponding devices may operate according to the operation instruction generated based on the power reduction policy, and thus, a whole system may operate at low power in optimal performance.

FIG. 3 is a block diagram illustrating an internal configuration of the decision-making tree model generator 191 illustrated in FIG. 2.

Referring to FIG. 3, the decision-making tree model generator 191 may include a state value divider 191-1, a node constructor 191-3, a category classifier 191-5, and a tree structure generator 191-7.

The state value divider 191-1 may divide state information, measured by all devices included in the electrode device 110 or specific devices selected by the user, into a plurality of stages. That is, when expressing a state value included in the state information or a state value obtained by digitizing the state information, the state value divider 191-1 may divide a whole range of an expressible state value into a plurality of stages. In this case, the number of stages obtained through the division may be selected by the user.

The following Table 1 shows an example where a whole range is divided into a total of four stages when a whole range of a CPU utilization rate is expressed as 0% to 100%, a whole range is divided into a total of five stages when a whole range of CPI is expressed as 0 to 1.0, and a whole range is divided into a total of four stages when a whole range of a network bandwidth utilization rate is expressed as 0% to 100%.

TABLE 1

| | Stage 1 | Stage 2 | Stage 3 | Stage 4 | Stage 5 |
|---|---|---|---|---|---|
| CPU Utilization | 0 < cpu ≦ 19 | 20 ≦ cpu ≦ 49 | 50 ≦ cpu ≦ 79 | 80 ≦ cpu ≦ 100 | |
| Rate (%) | | | | | |
| CPI | 0 ≦ cpi < 0.2 | 0.2 < cpi < 0.5 | 0.5 < cpi < 0.7 | 0.7 < cpi < 1.0 | 1.0 ≦ cpi |
| Network | net < 1 | 1 ≦ net < 10 | 10 ≦ net < 50 | 50 ≦ net ≦ 100 | |
| Bandwidth | | | | | |
| Utilization Rate | | | | | |
| (%) | | | | | |

The node constructor 191-3 may construct a node corresponding to each of the stages obtained through the division by the state value divider 191-1. For example, in Table 1, the CPU utilization rate may be represented by a total of four nodes by stages, the CPI may be represented by a total of five nodes by stages, and the network bandwidth utilization rate may be represented by a total of four nodes by stages.

The category classifier 191-5 may classify nodes, constructed for each of the stages, into a plurality of categories according to the power reduction policy established by the user. For example, the category classifier 191-5 may classify a node, representing the CPU utilization rate mapped to the stage 1, into a category 4, and may classify a node, representing the CPU utilization rate mapped to the stage 2, and a node, representing the CPI mapped to the stage 1, into the category 4.

The tree structurer generator 191-7 may construct a tree structure by using the plurality of nodes classified by categories to generate the decision-making tree model.

FIG. 4 is a diagram illustrating an example of a decision-making tree generated by the decision-making tree model generator 191 illustrated in FIG. 3.

Referring to FIG. 4, in a decision-making tree according to an embodiment of the present invention, state values of devices may be classified into five categories “cat1 to cat5”.

In the decision-making tree according to an embodiment of the present invention, a termination node of each tree may be mapped to a corresponding category. For example, in FIG. 4, the category 4 “cat4” may be mapped to a termination node N1, and the category 5 “cat5” may be mapped to a node N3 which is a termination node in a tree where a node N2 is linked to the node N3.

Nodes classified (or mapped) into categories may correspond to a combination (a set) of state values which are to be controlled by the user for reducing power.

The category 4 “cat4” may be in a state where a CPU utilization rate of the processor 120 is very high. The category 4 “cat4” may be a set of state values which are to be controlled in order for the electronic device 100 to operate at maximum performance, irrespective of states of the other devices. That is, the user may establish a power reduction policy for performing control in order for hardware, such as a CPU, a memory, and/or the like closely related to system performance, to be executed at a maximum operation frequency.

In the category 5 “cat5”, since the CPU utilization rate is less than 50% but the CPI is less than 0.2, an operation execution rate focusing on the CPU is very high. In the category 5 “cat5”, performing control to quickly complete an operation by maximally increasing performance of the CPU is efficient for power reduction.

Therefore, in the category 5 “cat5”, the user may establish a power reduction policy where an execution frequency of the CPU is controlled to a maximum execution frequency (or a maximum operation frequency) by controlling dynamic voltage and frequency scaling (DVFS) of the CPU.

As described above, the electronic device 100 according to an embodiment of the present invention may classify state information about each of various resources (physical devices) into a specific category (or a specific group) by using a decision-making tree and may control an operation of each of the resources (physical devices) according to a power reduction policy established based on the specific category, thereby consuming low power and operating in an optimal state.

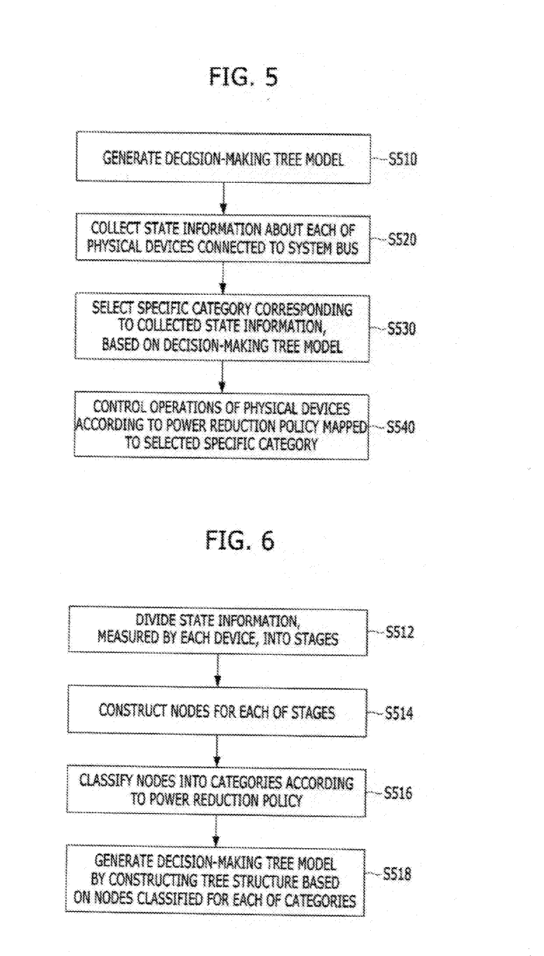

FIG. 5 is a flowchart illustrating a process of a power reduction method in an electronic device according to an embodiment of the present invention. In describing the following steps, details which are the same as or similar to the descriptions made above with reference to FIGS. 1 to 4 are omitted or will be briefly described. Unless specially described, the following steps are assumed as being performed by the power controller 190 illustrated in FIG. 1.

Referring to FIG. 5, first, in step S510, the power controller 190 may learn state information about a plurality of physical devices and may model an optimal power reduction policy to generate a decision-making tree model. A process of generating the decision-making tree model will be described below with reference to FIG. 6.

Subsequently, in step S520, the power controller 190 may collect the state information about each of the physical devices through a system bus. The state information may be collected by a sliding window unit. In this case, state values obtained by digitizing the state information may be accumulated by the number of sliding windows, and an average value of the accumulated state values may be calculated.

Subsequently, in step S530, the power controller 190 may select a specific category corresponding to the collected state information, based on the decision-making tree model. That is, a specific category corresponding to the average value which has been calculated in step S520 may be selected.

Subsequently, in step S540, the power controller 190 may control operations of the plurality of physical devices according to a power reduction policy mapped to the selected specific category.

FIG. 6 is a flowchart illustrating a detailed process of the decision-making tree model illustrated in FIG. 5.

Referring to FIG. 6, first, in step S512, the power controller 190 may divide state information, measured by each device, into a plurality of stages. That is, when expressing the state information as a state value obtained through digitization, the power controller 190 may divide a whole range of an expressible state value into a plurality of stages.

Subsequently, in step S514, a plurality of nodes may be constructed for each of the plurality of stages.

Subsequently, in step S516, the plurality of nodes may be classified into a plurality of categories according to the power reduction policy.

Subsequently, in step S518, the decision-making tree model may be generated by constructing a tree structure based on the plurality of nodes classified for each of the plurality of categories.

As described above, according to the embodiments of the present invention, an operating state of an electronic device may be dynamically classified based on a decision-making tree generated based on a user policy, and an operation of the electronic device may be controlled based on a power reduction policy optimized for the classified operating state, thereby controlling the electronic device at low power and optimal performance.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An electronic device comprising:
a system bus;
a hardware including a plurality of physical devices connected to the system bus; and
a power controller connected to the system bus to collect through the system bus state information about each of the plurality of physical devices, select a specific category corresponding to the collected state information by using a previously constructed decision-making tree model, and control an operation of each of the plurality of physical devices according to a power reduction policy mapped to the selected specific category.

2. The electronic device of claim 1, wherein the power controller comprises:
an information collector configured to collect the state information;
a category selector configured to select the specific category, corresponding to the collected state information, from among a plurality of categories previously obtained through classification based on the decision-making tree model; and
a device controller configured to control operations of the plurality of physical devices, based on the power reduction policy mapped to the specific category.

3. The electronic device of claim 2, wherein the information collector collects the state information by a sliding window unit.

4. The electronic device of claim 2, wherein the information collector accumulates state values which are obtained through digitization and are included in the state information, and transfers an average value of the accumulated state values to the category selector.

5. The electronic device of claim 4, wherein the category selector selects the specific category, corresponding to the average value, from among the plurality of categories.

6. The electronic device of claim 1, wherein the power controller comprises a decision-making tree model generator configured to learn state information about each of the plurality of physical devices to generate the decision-making tree model based on modeling of an optimal power reduction policy.

7. The electronic device of claim 6, wherein the decision-making tree model generator comprises:
a state value divider configured to, when expressing the state information as a state value obtained through digitization, divide a whole range of an expressible state value into a plurality of stages;
a node constructor configured to construct a plurality of nodes corresponding to each of the plurality of stages;
a category classifier configured to classify the plurality of nodes into a plurality of categories according to the power reduction policy; and
a tree structurer generator configured to construct a tree structure by using the plurality of nodes classified for each of the plurality of categories to generate the decision-making tree model.

8. A method of reducing power of an electronic device including a plurality of physical devices connected to a system bus, the method comprising:
collecting through the system bus state information about each of the plurality of physical devices;
selecting a specific category corresponding to the collected state information by using a previously constructed decision-making tree model; and
controlling operations of the plurality of physical devices according to a power reduction policy mapped to the selected specific category.

9. The method of claim 8, wherein the selecting of the specific category comprises selecting the specific category, corresponding to the collected state information, from among a plurality of categories previously obtained through classification based on the decision-making tree model.

10. The method of claim 9, wherein the plurality of categories are respectively mapped to a plurality of power reduction policies previously established by a user.

11. The method of claim 8, wherein the collecting of the state information comprises:
collecting the state information by a sliding window unit;
when expressing the state information as a state value obtained through digitization, accumulating state values by predetermined number of sliding windows; and
calculating an average value of the accumulated state values.

12. The method of claim 11, wherein the selecting of the specific category comprises selecting the specific category corresponding to the average value.

13. The method of claim 8, further comprising: learning state information about each of the plurality of physical devices to generate the decision-making tree model based on modeling of an optimal power reduction policy.

14. The method of claim 13, wherein the generating of the decision-making tree model comprises:
when expressing the state information as a state value obtained through digitization, dividing a whole range of an expressible state value into a plurality of stages;
constructing a plurality of nodes corresponding to each of the plurality of stages;
classifying the plurality of nodes into a plurality of categories according to the power reduction policy; and
constructing a tree structure by using the plurality of nodes classified for each of the plurality of categories to generate the decision-making tree model.
